(19) United States
(12) Patent Application Publication
(10) Pub. No.: US 2006/0167898 A1
(43) Pub. Date: Jul. 27, 2006

(54) Network apparatus and device information acquisition method

(75) Inventors: Takamichi Muramatsu, Sagamihara-shi (JP); Yoshihisa Sakazaki, Chuo-ku (JP); Hirotsugu Kato, Kounosu-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/316,954

(22) Filed: Dec. 27, 2005

(30) Foreign Application Priority Data
Dec. 27, 2004 (JP) 2004-375444

(51) Int. Cl. G06F 7/00; G06F 17/30

(52) U.S. Cl. 707/10

(57) ABSTRACT

A network apparatus includes: a reception section that receives from a device connected to a network a URL for receiving service provided by the device; a storage section that stores the URL received by the reception section; and a provision section that selectively provides the URL stored in the storage section to a user.

The entire disclosure of Japanese Patent Application No. 2004-375444 filed on Dec. 27, 2004 including specification, claims, drawings and abstract is incorporated herein by reference in its entirety.

### BACKGROUND

1. Field

One embodiment of the invention relates to a network apparatus compatible with plug and play and a device information acquisition method of the network apparatus.

2. Description of the Related Art

A network apparatus compatible with plug and play is known as a network apparatus in a related art. (For example, refer to JP-A-2004-334896)

Hitherto, for the user to attempt to receive service of another device connected to a network, it has been necessary for the user to manually enter the URL to be specified in a network apparatus.

### SUMMARY

The invention may provide a network apparatus including: a reception section that receives from a device connected to a network a URL for receiving service provided by the device; a storage section that stores the URL received by the reception section; and a provision section that selectively provides the URL stored in the storage section to a user.

The invention may provide a device information acquisition method, including: receiving from a device that is connected to a network a URL to receive service provided by the device; storing the received URL; and providing the stored URL selectively to a user.

The invention may provide a computer program product for enabling a computer to acquire device information, including: software instructions for enabling the computer to perform predetermined operations; and a computer readable medium bearing the software instructions; wherein the predetermined operations includes: receiving from a device that is connected to a network a URL to receive service provided by the device; storing the received URL; and displaying the URL to the user by the use of a browser as one of favorite links of the user.

### BRIEF DESCRIPTION OF THE DRAWINGS

Embodiment may be described in detail with reference to the accompanying drawings, in which:

FIG. 1 is a block diagram to describe the configuration of an embodiment of an apparatus of the invention;

FIG. 2 is a flowchart to describe the URL calculation and storage operation in the apparatus of the invention;

FIG. 3 is a drawing to show an example of device information of a device;

FIG. 4 is a drawing to describe an example of obtaining true URL to receive service;

FIG. 5 is a drawing to describe an example of obtaining true URL to receive service;

FIG. 6 is a block diagram to describe the configuration of another embodiment of an apparatus of the invention;

FIG. 7 is a drawing showing one example of data table stored in the apparatus shown in FIG. 6; and

FIG. 8 is a drawing showing an example window of a browser that is executed in the apparatus shown in FIG. 6.

### DETAILED DESCRIPTION

The embodiments below typically are implemented as a computer controlled by software. The software in this case includes a program and data, the functions and effects of the invention are provided by making the most of computer hardware physically, and appropriate related arts are applied to portions where the related arts can be applied. Further, the specific types and configurations of hardware and software for embodying the invention, the software processing range, and the like can be changed as desired. Therefore, in the following description, a virtual function block diagram indicating the component functions of the invention as blocks is used. A program for operating a computer to embody the invention is also one form of the invention.

Referring now to the accompanying drawings, there are shown embodiments.

### FIRST EMBODIMENT

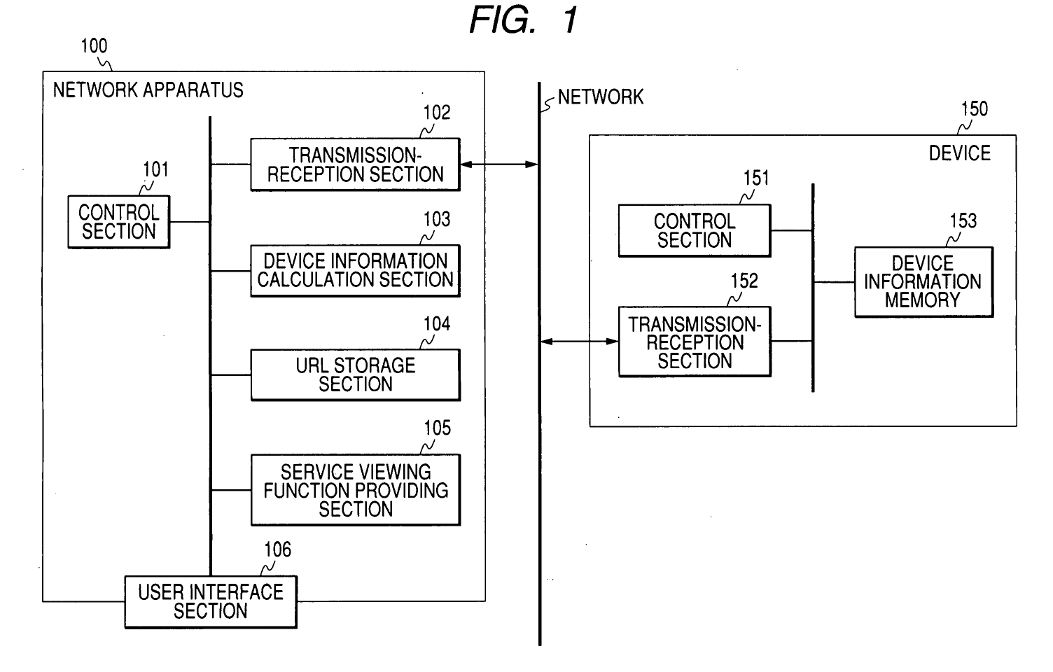

FIG. 1 is a block diagram to show the configuration of a network apparatus according to a first embodiment of the invention.

A network apparatus 100 is an apparatus compatible with UPnP (Universal Plug And Play) and is made up of a control section 101, a transmission-reception section 102, a device information calculation section 103, a URL storage section 104, a service viewing function providing section 105, and a user interface section 106.

The control section 101 is a control section for controlling the whole operation of the network apparatus 100 and is made up of a CPU, memory, etc., for example.

The transmission-reception section 102 transmits and receives data through a network.

The device information calculation section 103 analyzes device information and calculates the URL to be accessed to receive some service provided by the device.

The URL storage section 104 stores the URL calculated by the device information calculation section 103.

The service viewing function providing section 105 accesses URL stored in the URL storage section 104, thereby receiving the service provided by a device 150.

The user interface section 106 has an interface function with the user, for example, has a known GUI function. It is not the main section of the invention and therefore will not be discussed.

The device 150 compatible with UPnP (Universal Plug And Play) for the network and is made up of a control section 151, a transmission-reception section 152, and device information memory 153.

The control section 151 is a control section for controlling the whole operation of the device 150 and is made up of a CPU, memory, etc., for example.

The device information memory 153 stores device information of the device 150 described in an XML format.

The transmission-reception section 152 transmits and receives data to and from a different device through the network.

Next, the operation of the network apparatus 100 thus connected will be discussed. Unless otherwise specified, the operation is performed under the control of the control sections 101 and 151.

When the UPnP-compatible device 150 is connected to the network to which the UPnP-compatible network apparatus 100 belongs or when the UPnP-compatible network apparatus 100 is connected to the network to which the UPnP-compatible device 150 already belongs, the network apparatus 100 finds the device and determines the attributes in accordance with UPnP protocol and establishes interconnection with the device 150.

When the interconnection is established, the network apparatus 100 transmits a request for acquiring device information of the device 150 to the device 150 through the transmission-reception section 152.

Upon reception of the request for acquiring device information from the network apparatus 100 through the transmission-reception section 152, the device 150 reads the device information of the device 150 described in the XML format from the device information memory 153 and sends the device information to the network apparatus 100 through the transmission-reception section 152. The device information contains information of the URL to be accessed to receive service, the device type, etc., for example.

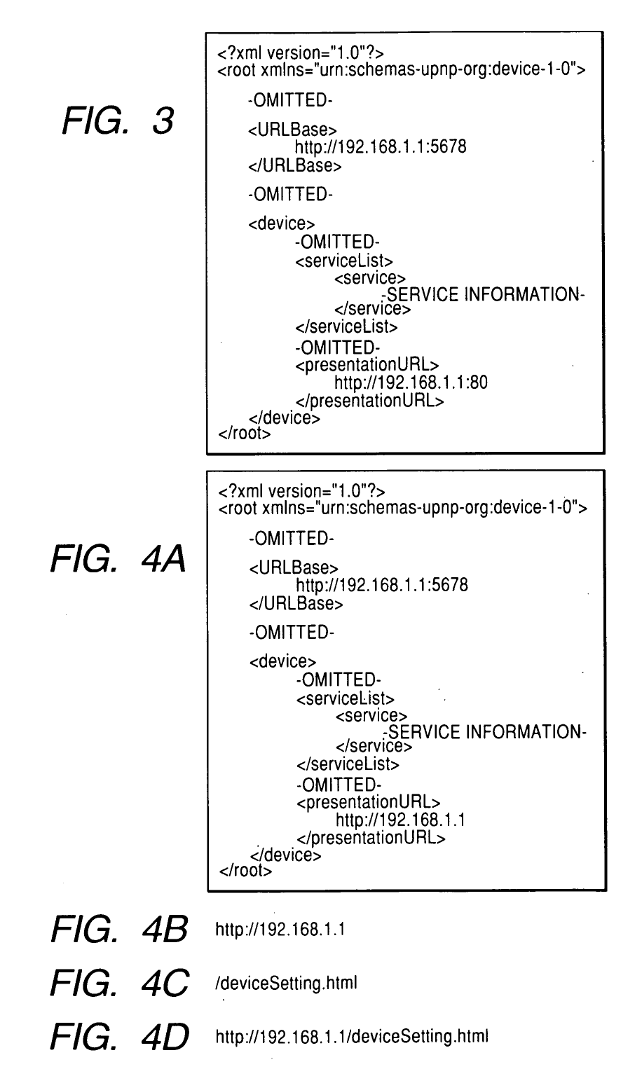

FIG. 3 is a drawing to show an example of the device information of the device 150 described in the XML format. In this example, the XML format is used as the device information Since any desired tag can be used in the XML, it is possible that a different tag may be used for each manufacturer although the same service is applied. To prevent this and make it possible to use tags regardless of the manufacture, the XML tags to be used are predetermined in organizations, the industry, etc., whereby the meanings of the XML tags can be understood regardless of the manufacture.

In the description of the example, it is assumed that use of “Presentation URL” element as the XML element for describing the URL to be accessed to receive service is predetermined in the standard of the industry, etc.

The network apparatus 100 acquires the device information of the device 150 through the transmission-reception section 102.

The network apparatus 100 passes the acquired device information of the device 150 described in the XML format to the device information calculation section 103 and requests the device information calculation section 103 to analyze the device information.

The device information calculation section 103 calculates the URL to be accessed by the network apparatus 100 to receive some service provided by the device 150 from the device information of the device 150.

In the device information of the device 150 shown in FIG. 3, description of the URL to be accessed in the “Presentation URL” element is predetermined in the standard, etc., and therefore the device information calculation section 103 calculates that the URL to be accessed is “http://192.168.1.1:80.” The number of URLs calculated by the device information calculation section 103 is not limited to one. Each URL provides different service and a plurality of URLs can also be calculated. For example, in addition to the “Presentation URL” element, an element for providing different service can be predetermined.

The term “some service” mentioned above may be service for enabling the current operation state of the device 150 to be known or service for enabling the function of the device 150 to be set, for example. The service is not limited to them.

Information concerning all services is not necessarily described in the URL calculated by the device information calculation section 103. For example, the following case is also possible. The URL used as the base is described in the device information of the device 150 and a predetermined character string is added to the base URL, whereby the URL to receive service (the URL to be accessed by the network apparatus 100) is obtained.

In an example in FIG. 4A, the URL used as the base is described in the “Presentation URL” element and a character string predetermined in response to the service is added to the URL, whereby the true URL to receive the service is obtained. In the example in FIG. 4A, the base URL is “http://192.168.1.1” shown in FIG. 4B. The network apparatus 100 suffixes a character string of “/deviceSetting.html” predetermined in the standard of the industry, etc., shown in FIG. 4C to the base URL “http://192.168.1.1” to obtain the true URL “http://192.168.1.1/deviceSetting.html” to receive the service shown in FIG. 4D, and accesses the true URL.

The calculation method of the URL to receive service is not limited to that in the example described above. For example, two special elements may be previously defined in the standard, etc., the reference URL may be contained in the first element, a relative URL to the URL specified in the first element may be defined in the second element, and the URL calculated from them may be the URL to receive service.

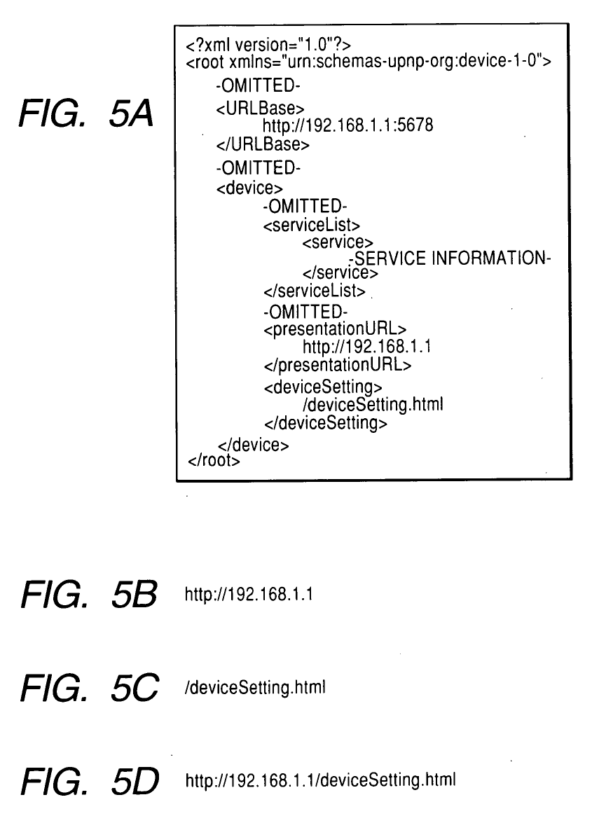

In an example in FIG. 5A, the URL used as the base is described in the “Presentation URL” element and a relative URL is described in the “/deviceSetting” element. These two are concatenated, whereby the true URL to receive the service is obtained. In the example in FIG. 5A, the base URL is “http://192.168.1.1” shown in FIG. 5B. A relative URL to the base URL is “deviceSetting.html” shown in FIG. 5C. From them, the true URL to receive the service is calculated as “http://192.168.1.1/deviceSetting.html” shown in FIG. 5D.

The control section 101 stores the URL calculated by the device information calculation section 103 in the URL storage section 104. If the form at of adding a predetermined character string is determined in the standard of the industry, etc., the true URL provided by suffixing the character string to the base URL may be stored or only the base URL may be stored.

If a plurality of URLs are calculated by the device information calculation section 103, the control section 101 may store the plurality of URLs in the URL storage section 104. The control section 101 need not necessarily store all URLs in the URL storage section 104; for example, the control section 101 may inquire of the user whether or not to store each URL through the user interface section 106, and may store only the URLs determined to be stored in the URL storage section 104.

The URL storage section 104 stores the URL calculated by the device information calculation section 103 under the control of the control section 101.

The service viewing function providing section 105 can acquire any URL stored in the URL storage section 104 at any time. The service viewing function providing section 105 can access any URL stored in the URL storage section 104, thereby receiving the service provided by the device 150.

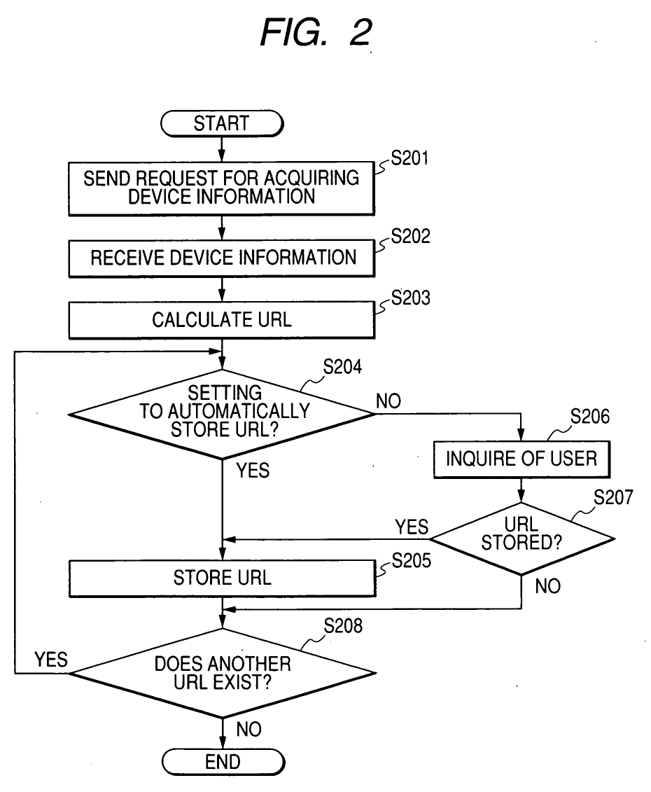

FIG. 2 is a flowchart to describe the URL calculation and storage operation in the network apparatus 100 of the invention.

In FIG. 2, after checking device detection by UPnP, the control section 101 sends a request for acquiring device information to the associated device 150 (step S201).

Next, the transmission-reception section 102 receives a response (device information) of the device 150 to the request (step S202).

Next, the control section 101 causes the device information calculation section 103 to interpret the response (device information) and calculate the URL(s) to be accessed to receive the service (step S203). The calculation method of the device information calculation section 103 is not limited as described above.

Next, the control section 101 performs the following operation for each of the URL(s) calculated by the device information calculation section 103. The control section 101 determines whether or not one attention URL is to be automatically registered without acquiring of the user (step S204).

If the control section 101 determines that the URL is to be automatically registered (YES at step S204), the control section 101 stores the URL in the URL storage section 104 (step S205); if the control section 101 determines that the URL is not to be automatically registered and that the control section 101 should inquire of the user whether or not to store the URL (NO at step S204), the control section 101 inquires of the user through the user interface section 106 (step S206).

If the control section 101 determines that the user is to store the URL as the result of the inquiry at step S206 (YES at step S207), the control section 101 goes to step S205 and stores the URL in the URL storage section 104.

After the URL is stored in the URL storage section 104 at step S205 or if it is not determined that the user is to store the URL (NO at step S207), the processing at step S204 and the later described above is repeated to the last URL (step S208).

Consequently, the URL required for the service is stored in the URL storage section 104, thus enabling the user of the network apparatus 100 to receive the service of the device 150 at any time.

### SECOND EMBODIMENT

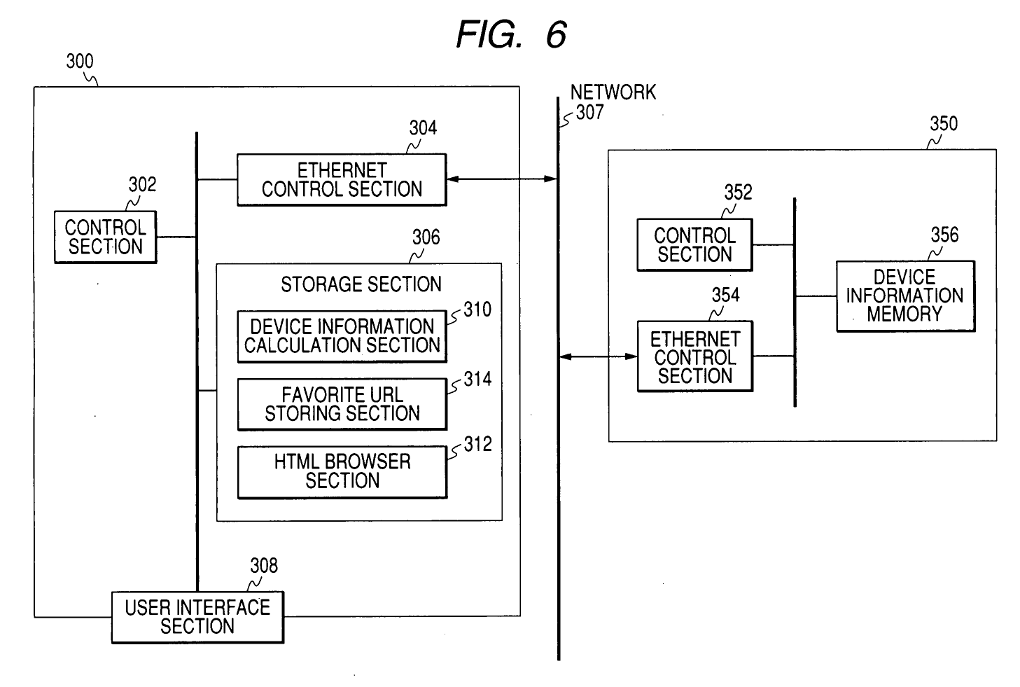

FIG. 6 is a block diagram to show the configuration of a network apparatus according to a second embodiment of the invention.

A network apparatus 300 is, for example, a digital television apparatus that is compatible with UPnP (Universal Plug And Play). The network apparatus 300 includes a control section 302, an Ethernet control section 304, a storage section 306 and a user interface section 308. The control section 304 has a CPU and controls the entire operations of the network apparatus 300. The Ethernet control section 304 transmits and receives data through the network 307 by the use of Ethernet. The user interface section 308 has an interface function with the user, for example, has a known GUI function, so that a user operates the network apparatus 300. The storage section 306 is configured by an HDD, a memory, etc., and includes a device information calculation section 310, an HTML browser section 312 and a favorite URL storing section 314. The device information calculation section 310 stores a program for analyzing device information provided by devices that are connected to the network 307 so as to calculate a URL to access to receive services that are provided by such devices. The HTML browser section 312 stores a program for operating an HTML browser, which is executable in the control section 302 so that it is operable by a user through the user interface section 308. The favorite URL storing section 314 stores URLs, a part of which are calculated by the device information calculation section 310.

As shown in FIG. 6, a device 350 is connectable to the network 307. The device 350 is, for example, a network printer which is also compatible with UPnP. The device 350 includes a control section 352 that controls the entire operation of the device 350, an Ethernet control section 354 that controls the transmission of data through the network 307 by the use of Ethernet. The device 350 also includes a device information memory 356 that stores device information of the device 350 described in an XML format.

When the interconnection is established between the network apparatus 300 and the device 350, the network apparatus 300 transmits a request for acquiring device information of the device 350 to the device 350 through the Ethernet control section 304.

On receiving the request from the network apparatus 300 through the Ethernet control section 354, the device 350 reads the device information in the XML format from the device information memory 356 and sends the device information to the network apparatus 300 through the Ethernet control section 354.

At the network apparatus 300, the Ethernet control section 302 receives the device information of the device 350 as a response to the request.

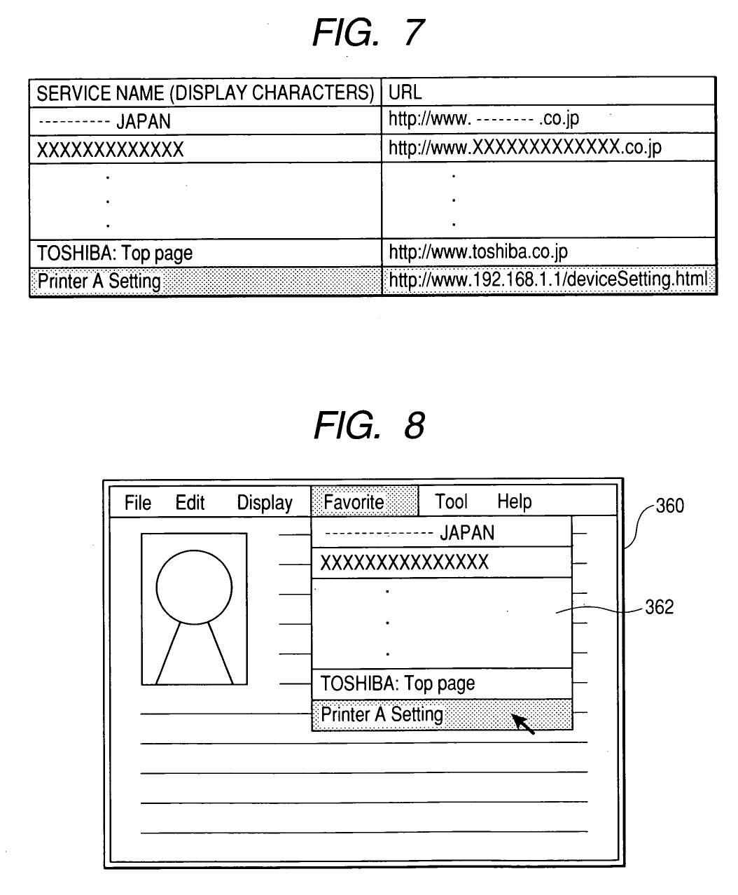

The control section 302 analyzes the device information and calculates the URL to be accessed to receive the service provided by the device 350, by executing the program stored in the device information calculation section 310. Then, the control section 302 registers the URL automatically or in accordance with a result of inquiry of the user through the user interface section 308, as one of the favorite links of the browser, and stores the URL in the favorite URL storing section 314. FIG. 7 is an example of a data table that is stored in the favorite URL storing section 314. As shown in FIG. 7, the URL to receive the service from the device 350 (Printer A Setting) is registered in the same manner as common websites (referred to as www.co.jp, etc.) The URL and its corresponding display characters are newly added in the data table shown in FIG. 7.

When the user operates to launch the HTML browser at the user interface section 308, the control section 302 executes the HTML browser program stored in the HTML browser section 312. FIG. 8 shows an example of a window 360 of the HTML browser which is displayed in the user interface section 308. As shown in FIG. 8, the browser selectively displays in its window the URL to receive the service from the device 350 (Printer A setting) as one of the favorite links 362.

As a result, the user can easily select the URL so that the network apparatus 300 receives the service of the device 350, without manually inputting the URL at the user interface section 308. Accordingly, the usability for receiving the service at the network apparatus 300 can be enhanced.

It is to be understood that the invention is not limited to the specific embodiments described above and that the invention can be embodied with the components modified without departing from the spirit and scope of the invention. The invention can be embodied in various forms according to appropriate combinations of the components disclosed in the embodiment described above. For example, some components may be deleted from all components shown in the embodiment. Further, the components in different embodiments may be used appropriately in combination.

What is claimed is:

1. A network apparatus comprising:
a reception section that receives from a device connected to a network a URL for receiving service provided by the device;
a storage section that stores the URL received by the reception section; and
a provision section that selectively provides the URL stored in the storage section to a user.

2. The network apparatus according to claim 1,
wherein the provision section displays the URL by the use of a browser.

3. The network apparatus according to claim 1,
wherein the browser displays the URL as one of favorite links of the user.

4. The network apparatus according to claim 1, further comprising:
a device information acquisition section that acquires device information to receive the service provided by the device from the URL provided at the provision section.

5. The network apparatus according to claim 1, further comprising: an interconnection section;
wherein the network apparatus is compatible with plug and play; and
when a plug-and-play-compatible device is connected to the network to which the network apparatus belongs, the interconnection section finds the plug-and-play-compatible device and determines attributes of the device in accordance with UPnP protocol to establish an interconnection with the plug-and-play-compatible device.

6. The network apparatus according to claim 1, further comprising: an interconnection section;
wherein the network apparatus is compatible with plug and play; and
when the network apparatus is connected to the network to which a plug-and-play-compatible device already belongs, the interconnection section finds the device and determines attributes of the plug-and-play-compatible device in accordance with UPnP protocol to establish an interconnection with the plug-and-play-compatible device.

7. The network apparatus according to claim 1,
wherein the device information is described in an XML format; and
the URL is calculated by analyzing XML.

8. A device information acquisition method, comprising:
receiving from a device that is connected to a network a URL to receive a service provided by the device;
storing the received URL; and
providing the stored URL selectively to a user.

9. The device information acquisition method, according to claim 8,
wherein the providing step includes displaying the URL to the user by the use of a browser.

10. The device information acquisition method, according to claim 8,
wherein the providing step includes displaying the URL to the user by the use of a browser as one of favorite links of the user.

11. The device information acquisition method, according to claim 8, further comprising:
acquiring device information to receive the service provided by the device when the user selects the URL that is selectively provided.

12. A computer program product for enabling a computer to acquire device information, comprising:
software instructions for enabling the computer to perform predetermined operations; and
a computer readable medium bearing the software instructions;
wherein the predetermined operations includes:
receiving from a device that is connected to a network a URL to receive service provided by the device;
storing the received URL; and
displaying the URL to the user by the use of a browser as one of favorite links of the user.
